(19) United States
(12) Patent Application Publication
(10) Pub. No.: US 2015/0341411 A1
(43) Pub. Date: Nov. 26, 2015

(54) Apparatus and Method for Controlling Adaptive Streaming of Media

(71) Applicant: TELEFONAKTIEBOLAGET L M ERICSSON (PUBL), Stockholm (SE)

(72) Inventors: Michael HUBER, Taby (SE); Vincent HUANG, Sollentuna (SE)

(73) Assignee: TELEFONAKTIEBOLAGET L M ERICSSON (PUBL), Stockholm (SE)

(21) Appl. No.: 14/759,125

(22) PCT Filed: Jan. 10, 2013
(86) PCT No.: PCT/EP2013/050415

§ 371 Date: Jul. 2, 2015

(51) Int. Cl. H04L 29/06; G06F 3/01; H04L 29/08

(52) U.S. Cl. CPC H04L 65/601; H04L 65/608; H04L 67/02; G06F 3/013

(57) ABSTRACT

A method for controlling adaptive streaming of media comprising video content is disclosed. The method comprises the steps of managing a quality representation of the video content according to available resources (step 120), detecting user engagement with the video content (step 130) and checking for continued user engagement with the video content (step 140). The method further comprises the step of reducing the quality representation of the video content on identifying an interruption of user engagement with the video content (step 150). Also disclosed are a computer program product for carrying out a method of controlling adaptive streaming of media comprising video content and a system (200) configured to control adaptive streaming of media comprising video content.

### TECHNICAL FIELD

The present invention relates to an apparatus and method for controlling adaptive streaming of media. The present invention also relates to a computer program product configured, when run on a computer, to effect a method for controlling adaptive streaming of media.

### BACKGROUND

Adaptive bitrate streaming (ABS) is a technique used in streaming multimedia over computer networks which is becoming increasingly popular for the delivery of video services. Current adaptive streaming technologies are almost exclusively based upon HTTP and are designed to operate over large distributed HTTP networks such as the internet. Adaptive HTTP streaming (AHS) supports both video on demand and live video, enabling the delivery of a wide range of video services to users. The default transport bearer for AHS is typically Unicast, although media can also be broadcast to multiple users within a network cell using the broadcast mechanism in the Long Term Evolution (LTE) standard.

A number of different adaptive HTTP streaming solutions exist. These include HTTP Live Streaming (HLS) by Apple®, SmoothStreaming (ISM) from Microsoft®, 3GP Dynamic Adaptive Streaming over HTTP (3GP-DASH), MPEG Dynamic Adaptive Streaming over HTTP (MPEG-DASH), OITV HTTP Adaptive Streaming (OITV-HAS) of the Open IPTV Forum, Dynamic Streaming by Adobe® and many more.

Adaptive HTTP streaming techniques rely on the client to select media quality for streaming. The server or content provider uses a “manifest file” to describe all of the different quality representations (media bitrates) that are available to the client for streaming a particular content or media, and how these different quality representations can be accessed from the server. The manifest file is fetched at least once at the beginning of the streaming session and may be updated.

Most of the adaptive HTTP streaming techniques require a client to continuously fetch media segments from a server. A certain amount of media time (e.g. 10 sec of media data) is contained in a typical media segment. The creation of the addresses or URIs for downloading the segments of the different quality representations is described in the manifest file. The client fetches each media segment from an appropriate quality representation according to current conditions and requirements.

FIG. 1 shows a representative overview of the process of adaptive bitrate streaming. High bitrate multimedia is input to an encoder 2, which encodes the multimedia at various different bitrates, illustrated schematically in the Figure by differently sized arrows. High bitrate encoding offers high quality representation but requires greater bandwidth and CPU capacity than a lower bitrate, lower quality encoding. A server 20 supporting the streaming process makes all of the encoded streams available to a user accessing the streamed content via a user equipment 10. The server 20 makes a manifest file available to the user equipment 10, enabling the user equipment 10 to fetch media segments from the appropriate encoded stream according for example to current bandwidth availability and CPU capacity.

FIG. 2 depicts in more detail the principle of how segments may be fetched by a user equipment device 10 from a server node 20 using an adaptive HTTP streaming technique. In step 22 the user equipment device 10 requests a manifest file from the server node 20, which manifest file is delivered to the user equipment 10 in step 24. The user equipment 10 processes the manifest file, and in step 26 requests a first segment of media at a particular quality level. Typically, the first segment requested will be of the lowest quality level available. The requested segment is then downloaded from the server node 20 at step 28. The user equipment 10 continuously measures the link bitrate while downloading the media segment from the server node 20. Using the measured information about the link bitrate, the user equipment 10 is able to establish whether or not streaming of a higher quality level media segment can be supported with available network resource and CPU capacity. If a higher quality level can be supported, the user equipment 10 selects a different representation or quality level for the next segment, and sends for example an “HTTP GET Segment#2 from Medium Quality” message to the server node 20, as illustrated in step 30. Upon receipt of the request, the server node 20 streams a segment at the medium quality level, in step 32. The user equipment 10 continues to monitor the link bitrate while receiving media segments, and may change to another quality representation at any time.

From the above it can be seen that, in adaptive HTTP streaming, a video is encoded with multiple discrete bitrates and each bitrate stream is broken into multiple segments or “chunks” (for example 1-10 second segments). The i^{th} chunk from one bitrate stream is aligned in the video time line to the i^{th} chunk from another bitrate stream so that a user equipment device (or client device), such as a video player, can smoothly switch to a different bitrate at each chunk boundary.

Adaptive HTTP streaming (AHS) is thus based on bitrate decisions made by user equipment devices. The user equipment device measures its own link bitrate and decides on the bitrate it would prefer for downloading content, typically selecting the highest available content bitrate that it predicts the available bandwidth can cater for.

AHS content may be displayed using a range of different platforms and user equipment devices. Devices may include mobile phones, tablets and personal computers as well as televisions and set top boxes (STBs).

As noted above, adaptive bitrate streaming is becoming increasingly popular for the delivery of video services, with estimates placing the volume of video related traffic at over 60% of total network traffic in telecommunications networks. This increasing demand for video services places a significant burden on network resources, with network expansion struggling to keep up with the ever growing demand for network bandwidth. Limited network bandwidth acts as a bottleneck to delivery of video services over both wired and wireless networks, with available bandwidth placing an upper limit on video quality, as well as ultimately limiting the availability of video services to users.

### SUMMARY

It is an aim of the present invention to provide a method and apparatus which obviate or reduce at least one or more of the disadvantages mentioned above.

According to a first aspect of the present invention, there is provided a method for controlling adaptive streaming of media comprising video content, the method comprising managing a quality representation of the video content according to available resources, detecting user engagement with the video content, checking for continued user engagement with the video content, and reducing the quality representation of the video content on identifying an interruption of user engagement with the video content.

Aspects of the present invention thus enable reduction of the quality of streamed video content when user engagement with the content is interrupted. In this manner, network bandwidth requirements may be reduced when a user is not actually engaging with the streamed video content. Different levels of user engagement with streamed video content may be envisaged, from active watching of a display screen to merely being in the same room as a display screen. The streaming may for example be adaptive HTTP streaming or any other adaptive bitrate streaming protocol.

In some examples, the steps of managing a quality representation and reducing a quality representation may comprise instructing a user equipment to manage and/or reduce a quality representation as appropriate. Methods according to the present invention may thus be implemented within a user equipment device or in a separate system that communicates with a user equipment device responsible for streaming the media.

The streamed media may be any kind of multimedia, and the quality representation of the video content may be managed according to any suitable adaptive bitrate streaming protocol. In some examples, the quality representation of the video content may be managed according to available network bandwidth and CPU capacity.

In some examples, the step of checking for continued user engagement may comprise continuous checking or may comprise periodic checking, a time period for which may be set by a user, a user equipment manufacturer or any other suitable authority.

According to some examples of the present invention, an interruption of user engagement may comprise an absence of detected user engagement during a time period exceeding a threshold value. Thus an interruption of user engagement may be distinguished from a mere absence of detected user engagement. In this manner it may be ensured that quality is not reduced immediately user engagement can no longer be detected, but only after user engagement has been undetected for a time period longer than a threshold value. This may ensure that a very brief absence of detected user engagement does not trigger a reduction in video quality. The threshold value may be set by user, user equipment manufacturer or any other suitable authority, which may for example include a system implementing the method.

According to some examples, reducing a quality representation of the video content may comprise selecting a minimum available quality representation. A minimum quality representation may be a segment encoded at the lowest bitrate available from the server providing the content. In this manner, examples of the invention may ensure that a minimum of bandwidth is used when the user is not engaging with the video content.

According to some examples, the method may further comprise checking for resumption of user engagement with the video content, and interrupting streaming of the video content on identifying a prolonged interruption of user engagement with the video content. A prolonged interruption may for example comprise a continuous absence of detected user engagement for time period exceeding a second threshold value. The second threshold value may be greater than the threshold value defining an interruption of user engagement and may also be set by user, manufacturer of user equipment or other suitable authority. In this manner, demand for bandwidth may be reduced still further by ceasing to stream video altogether when the user has been unengaged with the video content for a set period of time. In some examples, the second threshold may be set by a system implementing the method, based on statistical data concerning previous user interruptions.

According to some examples, the method may further comprise the steps of checking for resumption of user engagement with the video content, and resuming management of quality representation of the video content on identifying a resumption of user engagement with the video content. In this manner, normal management of video quality representation may be resumed on detection of a resumption of user engagement with the video content. In some examples, normal management may be resumed with video quality representation at a pre-interruption level.

According to some examples, detecting user engagement with the video content may comprise detecting user presence within an engagement range of a video display screen. An engagement range may be defined according to various factors such as user requirements or user equipment. For example, an engagement range may be a region of space in front of a display screen, or may be extended to include the entirety of a room within which the screen is positioned.

According to some examples, detecting user presence may comprise detecting a user face within an engagement range of a video display screen.

According to further examples, detecting user engagement with the video content may comprise detecting user eye contact with an engagement range of a video display screen. Detecting user eye contact may comprise the use of eye tracking equipment and software. The engagement range may be defined according to user requirements or user equipment and may for example comprise a display screen or a display screen and a border around the screen.

According to some examples, the media may further comprise audio content, and the method may further comprise maintaining a quality representation of the audio content during an interruption of user engagement with the video content.

According to another aspect of the present invention, there is provided a computer program product configured, when run on a computer, to effect a method according to the first aspect of the present invention. Examples of the computer program product may be incorporated into an apparatus such as a user equipment device which may be configured to display streamed media content. Alternatively, examples of the computer program product may be incorporated into an apparatus for cooperating with a user equipment device configured to display streamed media content. The computer program product may be stored on a computer-readable medium, or it could, for example, be in the form of a signal such as a downloadable data signal, or it could be in any other form. Some or all of the computer program product may be made available via download from the internet.

According to another aspect of the present invention, there is provided a system for controlling adaptive streaming of media comprising video content by a user equipment, wherein the user equipment is configured to manage a quality representation of the video content according to available resources. The system comprises a detecting unit configured to detect user engagement with the video content, a control unit configured to identify interruption of user engagement with the video content, and a communication unit, configured to instruct the user equipment to reduce a quality representation of the video content on identification of an interruption of user engagement with the video content.

In some examples, the system may be realised within a user equipment device or within an apparatus for cooperating with a user equipment device. Units of the system may be functional units which may be realised in any combination of hardware and/or software.

According to some examples, the detecting unit may comprise at least one of a presence detector, a face detector and/or an eye tracker.

According to some examples, the control unit may be further configured to identify a prolonged interruption of user engagement with the video content, and the communication unit may be further configured to instruct the user equipment to interrupt streaming of the video content on identification of a prolonged interruption of user engagement with the video content.

According to some examples, the control unit may be further configured to identify a resumption of user engagement with the video content, and the communication unit may be further configured to instruct the user equipment to resume management of quality representation of the video content on identification of a resumption of user engagement with the video content.

According to some examples, the system may be configured for integration into the user equipment. The user equipment may for example be a mobile phone, tablet, personal computer, television or set top box.

### BRIEF DESCRIPTION OF THE DRAWINGS

For a better understanding of the present invention, and to show more clearly how it may be carried into effect, reference will now be made, by way of example only, to the following drawings in which:

FIG. 1 is a schematic representation of adaptive bitrate streaming;

FIG. 2 shows a typical messaging sequence in adaptive HTTP streaming;

FIG. 3 is a flow chart illustrating steps in a method for controlling adaptive streaming of media comprising video content;

FIG. 4 is a schematic representation of the effect of the method illustrated in FIG. 3;

FIG. 5 is a block diagram illustrating a system for controlling adaptive streaming of media comprising video content.

FIG. 6 is a flow chart illustrating steps in another example of a method for controlling adaptive streaming of media comprising video content.

### DETAILED DESCRIPTION

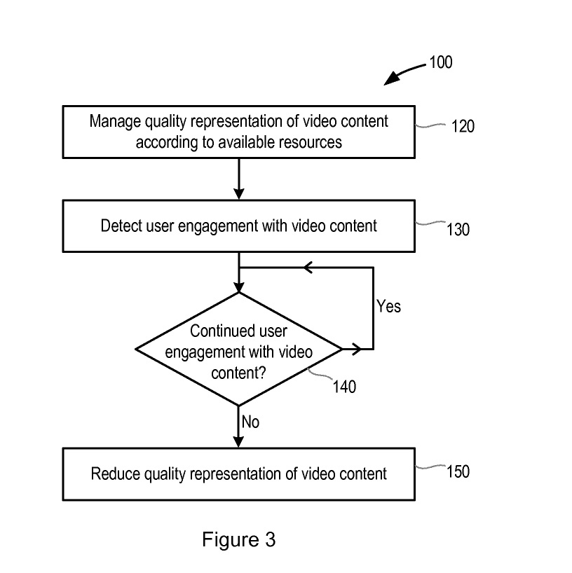

FIG. 3 illustrates steps in a method 100 for controlling adaptive streaming of media comprising video content. The streamed media may comprise any combination of multimedia which includes video content and may additionally comprise audio content. The media may be streamed using any streaming protocol which may for example include an adaptive bitrate streaming protocol. The following description discusses different adaptive HTTP streaming solutions, but it will be appreciated that aspects of the present invention are equally applicable to other ABS streaming protocols including for example RTP and RTSP.

With reference to FIG. 3, a first step 120 of the method 100 comprises managing a quality representation of the video content according to available resources. The method further comprises, in step 130, detecting user engagement with the video content and, in step 140, checking for continued user engagement with the video content. Finally, the method comprises, at step 150, reducing the quality representation of the video content on identifying an interruption of user engagement with the video content.

As discussed above, adaptive bitrate streaming protocols enable a client user equipment to manage a quality representation of streamed media content according to available network bandwidth and CPU capacity. The step 120 of managing a quality representation of the video content may therefore comprise conducting normal ABS streaming procedures to fetch segments of media at the highest available quality representation that can currently be supported. The quality representation of the video content may comprise the bitrate at which the content has been encoded. A range of different streaming solutions may achieve this function, including the presently available HTTP Live Streaming (HLS) by Apple®, SmoothStreaming (ISM) from Microsoft®, 3GP Dynamic Adaptive Streaming over HTTP (3GP-DASH), MPEG Dynamic Adaptive Streaming over HTTP (MPEG-DASH), OITV HTTP Adaptive Streaming (OITV-HAS) of the Open IPTV Forum, Dynamic Streaming by Adobe® and many more.

Referring again to FIG. 3, while managing a quality representation of the video content according to available resources, the method proceeds, at step 130, to detect user engagement with the video content. Different levels of user engagement may be envisaged, depending in some instances upon the nature of the user equipment being used to display the streamed media, and/or the requirements of a user. Different examples of user engagement, as well as solutions for detecting user engagement, are discussed below.

In a first example, user engagement with video content may be defined as a user being present in a room in which the video content is being displayed. This may be considered as a relatively low level of user engagement but may be appropriate in certain circumstances. For example, a large display screen such as a wide screen television or home cinema system can be seen from a considerable distance. It is therefore possible for a user to actively engage with video content displayed on the screen while remaining at some distance from the screen. The presence of a user in the same room as the screen may therefore be sufficient to signify user engagement with the displayed video content.

In other examples, user engagement may be signified by user presence within a defined region extending a set distance from the display screen. A user present within this “engagement range” may be considered to be engaging with the video content displayed on the screen. In the previous example, the engagement range may be considered to comprise the entire room within which the screen is positioned. However, in other examples, it may be appropriate to define a smaller engagement range around the screen. This definition of engagement range may be suitable for example in a large open plan home environment, where a single room may serve multiple functions. Considering a television positioned in an entertainment area of an open plan living space, the engagement range may comprise the entertainment area, but may not include a kitchen, dining or other area of the open plan space. While a user in a kitchen or dining area may still be listening to streamed audio content, it is unlikely that they will be continuously observing the streamed video content, and thus may not be considered to be engaging with the video content. Users streaming music accompanied by video content may be concerned only with the audio content of the stream, and may thus continue streaming of multimedia while remaining in a different area of the living space and without engaging with the video content. Alternatively, a user may perform other tasks while listening to audio content, only returning to the entertainment area to engage with the video content when the audio content indicates that something of interest to the user is being displayed. In other examples, a user may be streaming three dimensional video content, which has a specific viewing range within which the three dimensional effect can be appreciated. Outside of this range, the user cannot effectively engagement with the three dimensional video content, and two dimensional content may be streamed, reducing bandwidth load and improving user experience.

A further example of engagement range may be envisaged in the case of a smaller display screen such as a tablet or mobile phone display screen. Such screens are considerably smaller than a television or home cinema screen, and engaging with displayed video content requires a user to be in a position substantially in front of the screen and at a relatively small separation from the screen. For such user equipment, a relatively small engagement range may be defined extending from the display screen to a distance of for example 1 m. User presence within this range may indicate user engagement with video content displayed on the screen.

User presence within an engagement range may be detected using a variety of available presence detection equipment and software, and it will be appreciated that a range of solutions for detecting user presence within a target area are available.

In some examples, a threshold of user engagement with video content may be placed somewhat higher, requiring not only user presence within an engagement range but the detection of a user face within an engagement range. User face detection within an engagement range indicates that not only is a user present in an area from which the video content can be engaged with, but that the user's face is directed substantially towards the screen on which the content is displayed. Various solutions for face detection are known in the art and can be used to detect a user face within a defined engagement range.

In other examples, user engagement with video content may be defined as user eye contact with a display screen on which the video content is displayed. This definition may be suitable in the case of smaller display screens such as tablets and mobile phones. Eye tracking technology enabling monitoring of user eye focus is relatively widely available. An engagement range consisting of a display screen and for example a small border extending around the display screen may be defined and user eye focus within this engagement range may be detected by eye tracking software and sensors. Eye focus within this range may signify user engagement with the displayed video content. Eye focus may also be used as an indication of user engagement with video content for other display situations. For example, user engagement may be defined as actively focussing on the displayed video content, and eye tracking may be used to distinguish between a user who is watching video content and a user who is positioned in front of a television but is not watching the screen because the user is reading, asleep or for other reasons.

The above discussion illustrates different levels of user engagement with video content which may be detected, and suggests ways in which such engagement may be detected. While certain levels of user engagement may be more appropriate for particular user equipment or display solutions, it will be appreciated that each display solution or situation may lend itself to a range of different user engagement levels. The level of user engagement to be detected may be determined and adjusted by a user or for example by a manufacturer of user equipment. In alternative examples, the level of user engagement to be detected may be learned by a system implementing the method.

Referring again to FIG. 3, having detected user engagement with the video content at step 130, the method proceeds at step 140 to check whether continued user engagement with the video content can be detected. This step may involve continuous or periodic checking to detect the measure of user engagement being employed. This may include continued presence detection, face detection or eye tracking, for example. Alternatively periodic checks on presence, face or eye focus may be made. The frequency with which such checks are made may be determined by a manufacturer or user equipment or may for example be programmed by a user as part of an equipment set up.

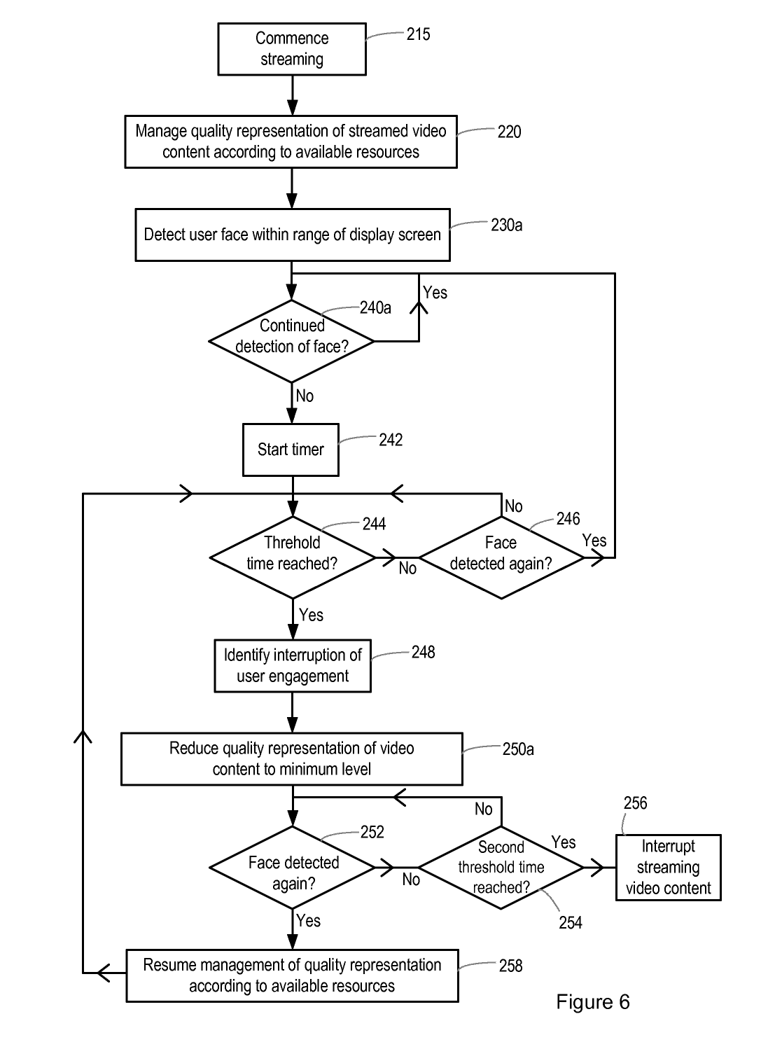

While continued user engagement with the video content is detected, the method takes no further action other than the continual or periodic monitoring of user engagement. If, however, continued user engagement cannot be detected, the method proceeds, at step 150, to reduce the quality representation of the video content. This reduction may comprise reducing an encoding bitrate of the video content fetched during the streaming process. In one example, the lowest available encoding bitrate may be selected. In other examples, a fixed reduction in quality representation from the last quality representation selected acceding to normal management procedures may be imposed. The reduction in quality representation of the video content at step 150 may be triggered by an interruption in continued user engagement, which interruption may be defined as an absence in continued user engagement which absence lasts for a period of time exceeding a threshold value. This arrangement is discussed in further detail below with reference to FIG. 6.

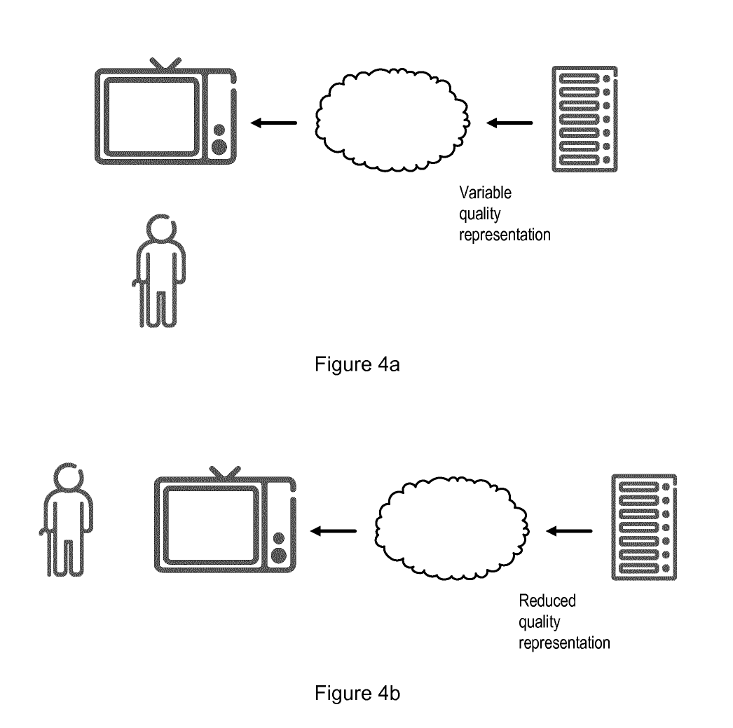

The effect of the method illustrated in FIG. 3 is represented in FIG. 4. FIG. 4 shows a first scenario (FIG. 4a) in which a user is engaging with streamed video content and the streaming protocol fetches video segments at a quality representation that varies according to available resources. FIG. 4 also illustrates a second scenario (FIG. 4b) in which a user is no longer engaging with the video content. Having detected this lack of user engagement with the video content, the streaming protocol is instructed to fetch video segments of reduced quality representation, thus reducing the bandwidth required to support the streaming while the best available quality representation is not required.

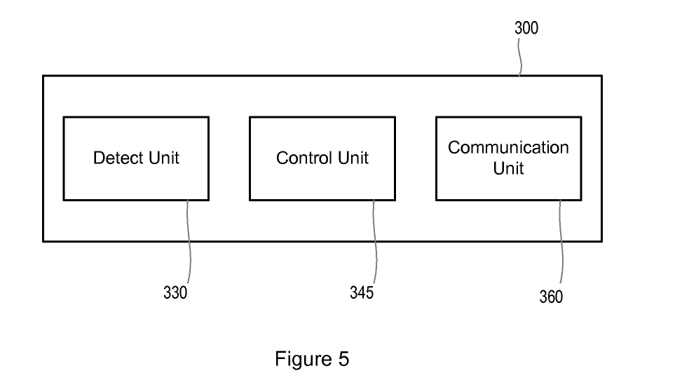

The method 100 of FIG. 3 may be realised by a computer program which may cause a system, processor or apparatus to execute the steps of the method 100. FIG. 5 illustrates functional units of a system 300 which may execute the steps of the method 100, for example according to computer readable instructions received from a computer program. The system 300 may for example be realised in one or more processors or any other suitable apparatus.

With reference to FIG. 5, the system 300 comprises a detecting unit 330, a control unit 345 and a communication unit 360. It will be understood that the units of the system are functional units, and may be realised in any appropriate combination of hardware and/or software.

According to an example of the invention, the detecting unit 330, control unit 345 and communication unit 360 may be configured to carry out the steps of the method 100 substantially as described above. The system 300 may cooperate with a user equipment configured to stream the media and incorporating a display screen. The system may be realised in a separate user apparatus which is in communication with the user equipment, or may be realised within the user equipment itself. The following description discusses an example in which the system 300 is realised within a separate user apparatus which is in communication with a user equipment configured to stream multimedia. Further examples discussed below illustrate alternative arrangements in which the system 300 is realised within the user equipment itself.

With reference to FIG. 5, an example of the system 300 cooperates with a user equipment to implement the method 100. The user equipment streams media including video content, and performs step 120 of the method 100, managing a quality representation of the video content according to available resources including bandwidth and CPU capacity.

The detecting unit 330 of the system is configured to detect user engagement with the video content. The detecting unit 330 may comprise one or more of a presence detecting equipment, a face detecting equipment and or an eye tracking equipment. The detecting equipment may comprise appropriate sensors such as a camera, distance sensor, movement sensor etc. The detecting unit 330 may comprise a combination of hardware and software enabling detection of presence or face and/or eye tracking, and may be programmed to detect user engagement with video content according to different definitions or levels of user engagement. Levels of user engagement for detection may include presence of a user within an engagement range, detection of a user face within an engagement range and/or eye focus within an engagement range. The definition or level of user engagement to be detected may be set according to the nature of the user equipment and/or user instructions.

In other examples, the detecting unit 330 may be configured to use readings from sensors mounted on the user equipment in order to detect user engagement according to an appropriate level or definition. In still further examples, the detecting unit 330 may be configured to use a combination of measurements from sensors mounted on or in communication with the user equipment, and sensors mounted on or in communication with the apparatus in which the system 300 is realised in order to detect user engagement with the video content.

The control unit 345 of the system is configured to identify interruption of user engagement with the video content. As discussed briefly above, an interruption of user engagement with video content may be defined to have a meaning distinct from a mere absence of continued user engagement with the video content. In one example, an interruption of user engagement with video content may be defined as a continuous absence of user engagement with the video content for a time period exceeding a first threshold value. This definition of an interruption, and use of interruption as a trigger for reduction in quality representation, may serve to distinguish between a significant absence of user engagement and a fleeting distraction. Taking the example of face detection, a sneeze or brief turn of the head to answer a question or respond to a distraction may be detected as an absence of user engagement in a situation in which continuous monitoring of user engagement is performed. However, an absence of this sort may be extremely brief, and it may be desirable to avoid a reduction in video content quality representation in such circumstances. By defining an interruption as an absence of greater than a threshold time duration, such minor distractions are not sufficient to trigger a reduction in video content quality representation. This use of an interruption as a condition for quality representation reduction is discussed in further detail with reference to FIG. 6.

The communication unit 360 of the system 300 is configured to instruct the user equipment with which the system 300 communicates to reduce a quality representation of the video content on identification by the control unit 345 of an interruption of user engagement with the video content. In examples in which the system 300 is realised within a user equipment, the communication unit may be configured to communicate with a video player system which is managing streaming of the media in question.

FIG. 6 illustrates steps in another example of method 200 for controlling adaptive streaming of media comprising video content. FIG. 6 illustrates how the steps of the method 100 illustrated in FIG. 3 may be further subdivided in order to realise the functionality described above. FIG. 6 also illustrates additional steps that may be incorporated in the method 100 to provide added functionality.

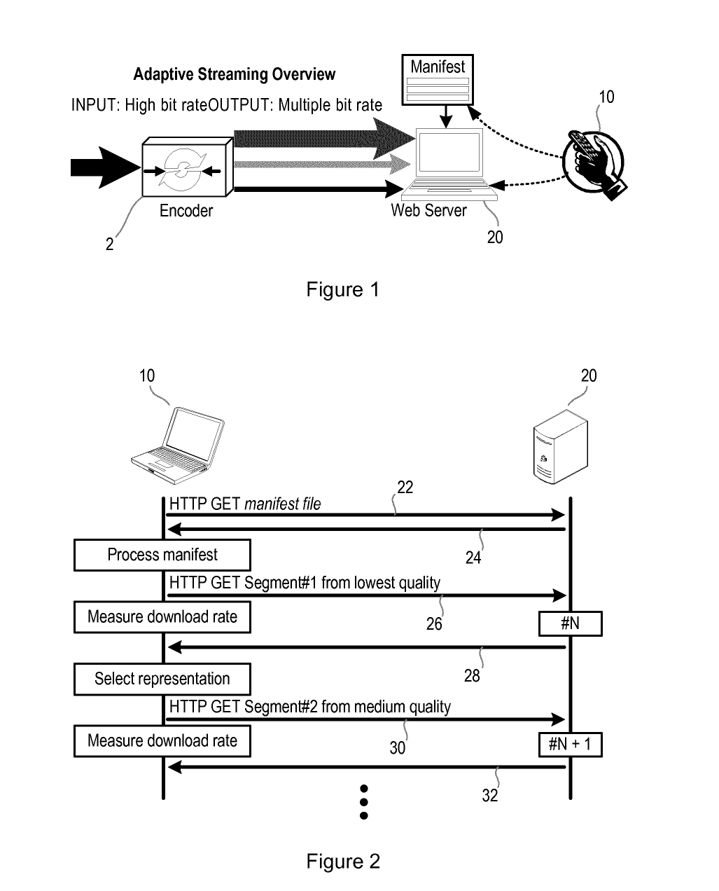

The method of FIG. 6 is described below with reference to steps conducted by units of the system 300 illustrated in FIG. 2, for example according to instructions from a computer program. In the present example, the system 300 is described as a system realised within a user equipment configured to stream multimedia. The system 300 is in communication with a video player realised within the user equipment and configured to manage streaming of the media. In the example discussed below, user engagement with video content is defined as detection of a user face within an engagement range of the user equipment streaming the media and including a screen on which the video content is displayed. It will be appreciated that variations to the example discussed below may be envisaged in which user engagement is defined differently, as discussed more fully above with reference to FIG. 1.

With reference to FIG. 6, in a first step 215, the video player commences streaming of the media including video content. The video player manages the quality representation of the video content according to available resources in step 220. This management may be according to any one of a range of available adaptive bitrate streaming solutions, examples of which are discussed above. The detecting unit 330 of the system 300 proceeds, in step 230a, to detect a user face within an engagement range of the display screen of the user equipment. As discussed above, the engagement range may vary from the immediate vicinity of the display screen to include the entirety of the room within which the screen is positioned. The engagement range may be defined according to user requirements and may for example include a suitable area around and in front of the screen, within which users watching the screen are likely to be positioned. Having detected at least one user face within the range of the display screen, the control unit, at step 240a, monitors whether or not the detecting unit is continuing to detect the user face within the engagement range. The control unit 345 may perform periodic checks at intervals of for example a few seconds to confirm that the detecting unit 330 is still detecting the user face. Alternatively, the control unit may make a continuous check for a positive detection of user face by the detecting unit 330. While the user face is detected, the control unit continues to check without taking any further action. In the event that the user face can no longer be detected by the detecting unit 330 (no at step 240a), the control unit starts a timer t at step 242 and checks at step 244 whether or not a first time threshold has been reached. The first time threshold may be set for example at between 5 seconds and 1 minute and in the present example may be set at 20 seconds. If the first time threshold has not been reached, the control unit checks at step 246 whether or not the user face has been detected again by the detecting unit 330. If the detecting unit 330 has detected the user face again (yes at step 246) then the control unit 345 returns to step 240a, checking for continued detection of the face by the detecting unit 330. This chain of actions signifies a brief absence of the face caused for example by a turn of the head, sneeze or other temporary distraction. As discussed above, this brief distraction is not sufficient to cause a reduction in video content quality representation, owing to the use of the first time threshold. The value of the first time threshold may be set according to user requirements or programmed by a manufacturer of user equipment.

If, on checking at step 246, the detecting unit still cannot detect the face, (no at step 246) the control unit continues to check for expiration of the first time threshold at step 244. Once the first time threshold has been reached (yes at step 244), the control unit 345 determines at step 248 that an interruption of user engagement with the video content has occurred. The communication unit 360 then instructs the video player to reduce the quality representation of the video content to a minimum level at step 250a.

After the quality representation level has been reduced, the control unit continues to check whether or not the detecting unit has detected the user face again at step 252. If the user face has been detected (yes at step 252) the communication unit 360 instructs the video player to resume management of the quality level of the video content according to available resources at step 258 and the control unit returns to step 240a to check for continued detection of the user face. This may happen for example in the event that a user leaves a room or entertainment area for a short while to answer the door, make a drink etc. During the time the user is not engaging with the video content, the quality of the content is reduced, releasing bandwidth for other network use. However, immediately on detecting that user engagement with the video content has resumed, the system returns to normal quality representation management, fetching the highest available quality representation that can be supported with available resources. In some examples, the system may reinitiate normal quality representation management at the quality representation level that was streamed immediately preceding the interruption in user engagement.

If the user face has not been detected at step 252, the control unit checks at step 254 whether or not a second time threshold, longer than the first time threshold, has been reached. The second time threshold may for example be set at between 10 and 30 minutes and may in the present example be set at 15 minutes. In some examples, the second threshold may be set by the system 300 based on data concerning previous interruptions of user engagement. For example if the system determines that an interruption of 10 minutes is prolonged to at least 20 minutes in 90% of cases then the system may set the second threshold to be 10 minutes.

If the second time threshold has not yet been reached, the control unit returns to step 252 to check whether or not the detecting unit has detected the user face. If the second time threshold has been reached (yes at step 254) this signifies that a prolonged interruption of user engagement has taken place. The communication unit then instructs the video player to interrupt streaming of the video content, thus further reducing the bandwidth requirements of the user equipment. A prolonged interruption may occur for example if a user is performing other tasks and merely listening to audio content, or is intending to return to focus on video content only when something of particular interest to the user is discussed.

It will be appreciated that further method steps (not illustrated) may include checking for a resumption of user engagement after interruption of streaming of video content at step 256, and resuming streaming of video content on detecting a resumption of user engagement. The streaming of video content may be resumed in order to coincide with uninterrupted streaming of audio content.

According to the above described examples, the reduction in quality representation and interruption in streaming are applied to the video content only. Thus in the event of multimedia streaming in which audio and video content can be treated separately, the audio content may continue to be streamed at a high quality while video content quality is reduced or video content streaming is interrupted. Audio streaming imposes lower bandwidth requirements than video streaming, and thus a user may continue to listen to audio content at high quality while bandwidth savings are made according to their engagement with video content.

It will be appreciated that variations to the above example may be made without departing from the scope of the appended claims. For example, user engagement may be detected in different manners including presence detection, eye tracking or in other ways. In addition, the precise division of functionality between units of the system 300 may vary from that described above. For example, it may be the detecting unit 330 which performs checks at steps 240a and 252, with the control unit 345 being informed when the detecting unit no longer detects a face or is able to detect a face again after a period of absence.

Methods according to the present invention may be implemented in hardware, or as software modules running on one or more processors. Methods may also be carried out according to the instructions of a computer program, and the present invention also provides a computer readable medium having stored thereon a program for carrying out any of the methods described herein. A computer program embodying the invention may be stored on a computer-readable medium, or it could, for example, be in the form of a signal such as a downloadable data signal provided from an Internet website, or it could be in any other form.

It should be noted that the above-mentioned examples illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for controlling adaptive streaming of media comprising video content, the method comprising:
managing a quality representation of the video content according to available resources;
detecting user engagement with the video content;
checking for continued user engagement with the video content; and
reducing the quality representation of the video content on identifying an interruption of user engagement with the video content.

2. A method as claimed in claim 1, wherein an interruption of user engagement comprises an absence of detected user engagement during a time period exceeding a threshold value.

3. A method as claimed in claim 1, wherein reducing a quality representation of the video content comprises selecting a minimum available quality representation.

4. A method as claimed in claim 1, further comprising:
checking for resumption of user engagement with the video content; and
interrupting streaming of the video content on identifying a prolonged interruption of user engagement with the video content.

5. A method as claimed in claim 1, further comprising:
checking for resumption of user engagement with the video content; and
resuming management of quality representation of the video content on identifying a resumption of user engagement with the video content.

6. A method as claimed in claim 1, wherein detecting user engagement with the video content comprises detecting user presence within an engagement range of a video display screen.

7. A method as claimed in claim 6, wherein detecting user presence comprises detecting a user face within an engagement range of a video display screen.

8. A method as claimed in claim 1, wherein detecting user engagement with the video content comprises detecting user eye contact with an engagement range of a video display screen.

9. A method as claimed in claim 1, wherein the media further comprises audio content, and wherein the method further comprises maintaining a quality representation of the audio content during an interruption of user engagement with the video content.

10. A computer program product configured, when run on a computer, to effect a method as claimed in claim 1.

11. A system for controlling adaptive streaming of media comprising video content by a user equipment, wherein the user equipment is configured to manage a quality representation of the video content according to available resources, the system comprising:
a detecting unit configured to detect user engagement with the video content;
a control unit configured to identify interruption of user engagement with the video content; and
a communication unit, configured to instruct the user equipment to reduce a quality representation of the video content on identification of an interruption of user engagement with the video content.

12. A system as claimed in claim 11, wherein the detecting unit comprises at least one of: a presence detector, a face detector and/or an eye tracker.

13. A system as claimed in claim 11, wherein the control unit is further configured to identify a prolonged interruption of user engagement with the video content, and the communication unit is further configured to instruct the user equipment to interrupt streaming of the video content on identification of a prolonged interruption of user engagement with the video content.

14. A system as claimed in claim 11, wherein the control unit is further configured to identify a resumption of user engagement with the video content, and the communication unit is further configured to instruct the user equipment to resume management of quality representation of the video content on identification of a resumption of user engagement with the video content.

15. A system as claimed in claim 11, wherein the system is configured for integration into the user equipment.
